(19) United States
(12) Patent Application Publication
(10) Pub. No.: US 2012/0138072 A1
(43) Pub. Date: Jun. 7, 2012

(54) Custom fit appliance for Hygienic teeth and gum protection

(76) Inventor: Dale Council, Sunnyvale, CA (US)

(21) Appl. No.: 12/938,796

(22) Filed: Jan. 18, 2011

Related U.S. Application Data
(60) Provisional application No. 61/257,775, filed on Nov. 3, 2009.

(51) Int. Cl. A61C 5/14

(52) U.S. Cl. 128/861

(57) ABSTRACT

A device for the protection of the upper and lower teeth and gums from debris and discoloring agents during the consumption of sustenance, enamel staining liquids or the inhalation of tobacco products. This appliance, one each for the upper and lower teeth and gums, is custom fit by way of exacting dental impressions via existing dental impression methods and will completely encase the teeth and gum area preventing any and all intrusions. This appliance is designed to be removable, reusable and nearly invisible to the naked eye. This appliance is constructed using a clear liquid Polymer that includes semi soft components for a comfortable fit over the gums and inside of the oral cavity and a rigid clear Polymer at the tooth line to facilitate normal eating habits.

### PREVIOUS FILING

This application emanates from a previous application filing (61257775) dated Nov. 3, 2009

### FIELD OF THE INVENTION

This invention relates to a device and process for the protection of teeth and gums. More particularly, this invention is directed to a custom fit dental apparatus for the protection of teeth and gums during eating, smoking or drinking.

### BACKGROUND OF THE INVENTION

### Material/Process

The end product includes both ridged and pliable areas. This is accomplished by utilizing two (2) existing NB type liquid Polymers. These Polymers are, at present purchased from the company Hapco Inc. They are from their STERalloy FDG 2000 Series and are the #2781 and the 2463 Polymers.

The 2463 (ridged) is an NB component liquid mixed at a 4A:1B ratio

The 2781 (pliable) is an NB component liquid mixed at a 4A:1B ratio

The process of manufacturing can be accomplished by one of two methods. Both processes start with a widely and commonly used process of a dental impression of both the upper and lower teeth sets in the oral cavity. Once a proper negative impression is complete a liquid Polymer, (currently the 2463), is mixed and pored into the mold and set to cure. Once cured the original dental mold is removed. This process is repeated yielding exact replicas of the uppers and lowers of the teeth sets.

### Cold Dip Method

The positive molds are coated with an approved release agent and set to dry. Once complete each mold in placed into the mixed 2781 and placed into a 25∞C oven to dry. This process is reputed 4 times to achieve four (4) coats. Each coat will follow a 20 minute gel time at 25.0C and full cure at 12 hours after final coat per manufacturers specifications. Once complete cure is attained the product is placed into a water bath and separated from mold. Product is trimmed and returned to the mold and is dipped, teeth only into the 2463 Polymer for the ridged aspect of the product. This step will also follow a 20-minute gel time at 25∞C and full cure at 12 hours after final coat per manufacturers specifications

### Forced Injection Method

The positive molds are coated with an approved release agent and set to dry. A new negative mold is created with an offset to define desired thickness and coated with an approved release agent and set to dry. Both positive and negative molds are mounted into a standard carrier and clamped. The liquid Polymer is force injected into the mold and place into oven for curing. This will follow a 20-minute gel time at 25∞C and full cure at 12 hours after final coat per manufacturers specifications.

### SUMMARY OF THE INVENTION

The current device is a hand made, custom fit mouth shield for the protection of teeth and gums during the process of eating, drinking and smoking. Densecure will prevent food particles from becoming lodged between the teeth as well as prevent food particles from becoming stuck between the teeth and gums. This product will prevent teeth staining during the consumption of liquids. Additionally when used during smoking it will prevent yellowing and discoloration to the teeth due to the contact of smoke.

### BRIEF DESCRIPTION OF THE DRAWINGS

FIG. 1 is the front view of the device.

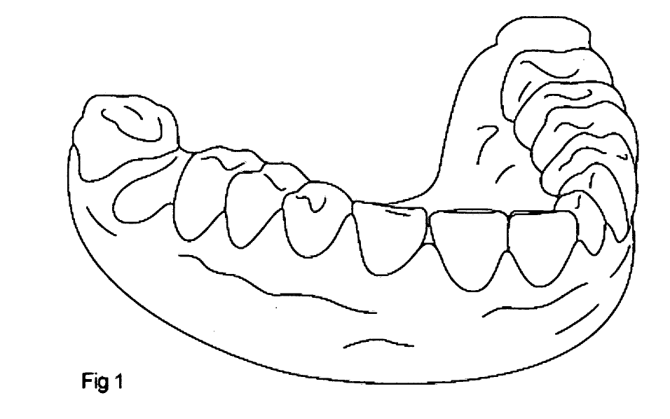

### DETAILED DESCRIPTION OF THE DRAWINGS

Figure one depicts the perspective, transparent view of the bottom/side. As seen, the device is custom fit to the patient and held in place through sizing resistance.

What is claimed is:

1. A custom fit appliance for Hygienic teeth and gum protection constructed of resilient and translucent material for protecting the teeth of a wearer comprising, a pair of allochiral arch-shaped members, each said arch-shaped member including a base portion having an inside surface professionally adapted by means of dental impressions to be engaged by the occlusal surfaces of the teeth of a wearer, each base portion including a front section and opposed substantially parallel side sections.

2. A custom fit appliance for Hygienic teeth and gum protection of claim 1 wherein the appliance is custom fabricated for each patient through patient specific dental impressions.

3. A custom fit appliance for Hygienic teeth and gum protection of claim 1 wherein the device is constructed of pliable and flexible materials.

4. A custom fit appliance for Hygienic teeth and gum protection of claim 1 wherein the appliance is translucent enough to avoid being noticed by others when in use.
